(19) United States
(12) Patent Application Publication
(10) Pub. No.: US 2005/0034564 A1
(43) Pub. Date: Feb. 17, 2005

(54) Light bulb changer/holder apparatus

(76) Inventor: Joseph Albrecht, Kansas City, MO (US)

Correspondence Address: Sonnenschein Nath & Rosenthal;Sears Tower, Wacker Drive Station, P.O. Box #061080, Chicago, IL, 60606-1080, US

(21) Appl. No.: 10/856,326

(22) Filed: May 28, 2004

Related U.S. Application Data
(60) Provisional application No. 60/474,641, filed on May 30, 2003.

(51) Int. Cl. H01K 3/32; F21S 8/00

(52) U.S. Cl. 81/53.11; 81/53.12

(57) ABSTRACT

An apparatus and method for grasping a light bulb is provided. The apparatus includes a pair of opposing fingers protruding from a base. A gap is positioned between the fingers to receive a light bulb, such as a tubular fluorescent light bulb. Once the light bulb is positioned within the gap, the apparatus is rotated and the fingers snap around the outer surface of the light bulb. The fingers are constructed of a generally elastic material to allow the fingers, which have an internal diameter smaller than the diameter of the bulb being grasped, to flex around the outer surface of the bulb. The apparatus includes a threaded cavity for receipt of a male threaded end of an extension pole.

This application claims priority pursuant to 35 U.S.C. 119(e) to co-pending U.S. Provisional Patent Application Ser. No. 60/474,641, filed May 30, 2003, the entire disclosure of which is incorporated herein by reference.

### FIELD OF THE INVENTION

The present invention relates generally to an apparatus for changing and/or holding light bulbs. More particularly, it is concerned with an apparatus to assist in changing fluorescent light bulbs using an extension pole or other similar extension device. The apparatus of the instant invention can also be utilized without an extension pole as a light bulb holder to safely support a fluorescent light bulb during storage or transport.

### BACKGROUND OF THE INVENTION

The use of an extension pole to change a light bulb is well known, and numerous examples of such light bulb changers exist in a wide variety of embodiments. Nevertheless, few such devices have been designed for use with fluorescent light bulbs, which present unique problems due to their long, narrow shape and relatively large size. All such prior art devices are extremely complex, difficult to operate, and extremely expensive to manufacture. One such device, sold by McGill Electrical Product Group, requires the user to angle a wedge portion of the changer between the bulb and socket and then rock the changer gently so that an engagement portion of the changer grasps the bulb. This device is cumbersome, requires a considerable amount of skill and dexterity to operate, requires that the changer device be used only on the socket side of spring-loaded fluorescent lamps, and is limited in the length of bulbs that it can accommodate.

Although very few devices exist for changing fluorescent light bulbs with an extension pole, such devices are extremely desirable because fluorescent lamps are used in many difficult. Therefore, it would be beneficial to provide a light bulb changer for use with an extension pole that is easy to operate and relatively inexpensive to manufacture.

Another common problem associated with fluorescent light bulbs involves storage and transportation of the bulbs. Certain fluorescent light bulbs are extremely expensive, thus avoiding breakage during transportation and storage is imperative. In that regard, it would be beneficial to provide a holder for fluorescent light bulbs that provides adequate support and stability during transportation and storage.

### SUMMARY OF THE INVENTION

An object of the instant invention is to provide an apparatus for use with an extension pole to change light bulbs. Another object of the instant invention is to provide an apparatus for use with an extension pole to change tubular light bulbs such as fluorescent light bulbs.

Another object of the instant invention is to provide a holder for supporting light bulbs during storage and transportation.

Yet another object of the instant invention is to provide an apparatus that can be used as either a light bulb changer or a light bulb holder that is easy to operate and inexpensive to manufacture.

The objects of the instant invention are accomplished through the use of a one-piece light bulb changer/holder that includes two upwardly extending fingers for securely grasping the bulb. The two fingers are located on opposing sides of the apparatus, and are spaced apart from one another to create a gap equal to, or slightly larger than, the diameter of the bulb. Each finger is curved to conform to the shape of a cylindrical fluorescent bulb, and has an inner diameter slightly smaller than the outer diameter of the bulb. The fingers are constructed of a moldable material such as Acetel plastic, nylon or any other material suitable to provide sufficient structure while simultaneously providing flexibility (or elasticity) of the fingers to engage and disengage the bulb. One finger curves upward clockwise from the base of the apparatus around the bulb to a termination point just past (clockwise) the upper-most point of the diameter of the bulb. The opposing finger curves upward from the base in a counterclockwise manner around the bulb to a termination point just past (counterclockwise) the upper-most point of the diameter of the bulb. The base of the apparatus of the instant invention includes internal threads for removably placing the apparatus on an extension pole.

In operation the instant invention is placed on the end of an extension pole. The pole is then used to position the apparatus such that the bulb is located within the gap between the fingers. The apparatus is then rotated clockwise such that the two fingers engage the bulb. As the apparatus is rotated the fingers will each slightly flex to wrap around the diameter of the bulb and to tightly hold the bulb. Once the apparatus is securely grasping the bulb, the pole can be easily manipulated to remove the bulb from the lamp socket. The bulb is then held securely in one hand while the apparatus is rotated counterclockwise to disengage the fingers from the bulb. A new bulb is then placed within the apparatus in the manner described above, and positioned in the socket via the extension pole.

In one embodiment of the instant invention, the threaded base is orientated such that the pole will be generally perpendicular to the tubular bulb being changed. This arrangement is particularly well-suited for manipulating spring-loaded (push-pull) bulbs, such as single pin fluorescent bulbs, in which it is necessary to slide the bulb along its tubular axis. In another embodiment of the instant invention the threaded base is angled to provide adequate space for rotation of a bulb, such as a bi-pin fluorescent bulb, which requires rotation about the tubular axis of the bulb for removal and installation in the socket. The angled base can be of unitary construction with the changer/holder, or alternatively, the angled base can be a separate component that threads into a threaded cavity in the changer/holder. In operation, a user will engage the bulb in the manner described above; however when the angled base is used, the pole will angle downward and away from the bulb, as opposed to a non-angled base, where the pole will be generally straight below the bulb. The user then pushes (or pulls) the pole in the direction towards the bulb, causing the bulb to rotate. As the pole reaches an alignment directly below the bulb, the user continues to push (or pull) the pole in the same direction until the pins are properly aligned to release the bulb from its socket. The bulb can the be lowered and removed from the changer/holder, and a new bulb can be installed in the socket by reversing the steps described above.

An alternative use for the apparatus of the instant invention is as a light bulb holder for use during transportation and storage. In a preferred embodiment, one holder of the present invention is placed at both ends of the bulb. The two holders are then mounted or otherwise positioned to safely support the bulb during transportation and storage. When it is desired to use the bulb, the holders can be removed in the manner described above (counterclockwise rotation), and the holders can then be saved for future usage.

In one embodiment of the instant invention, groves are cut toward the ends of the fingers, and rubber rings are wrapped around the fingers within the groves. The rubber will extend slightly beyond the grove to provide additional grip between the finger and the bulb.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is a front elevation view of a holder/changer of the instant invention.

FIG. 2 is a bottom plan view of the holder/changer of FIG. 1.

FIG. 3 is a side elevation view of the holder/changer of FIG. 1.

FIG. 4 is a top plan view of the holder/changer of FIG. 1.

FIG. 5 is a perspective view of the holder/changer of FIG. 1.

FIG. 6 is a sectional view of a threaded base cavity for a holder/changer of the instant invention.

FIG. 7 s a side elevation view of an alternative embodiment of the holder/changer of the instant invention.

### DETAILED DESCRIPTION OF PREFERRED EMBODIMENTS

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

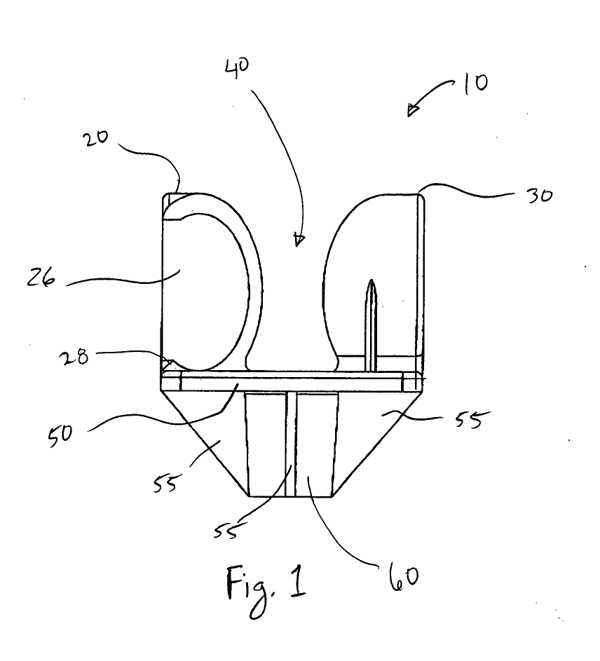

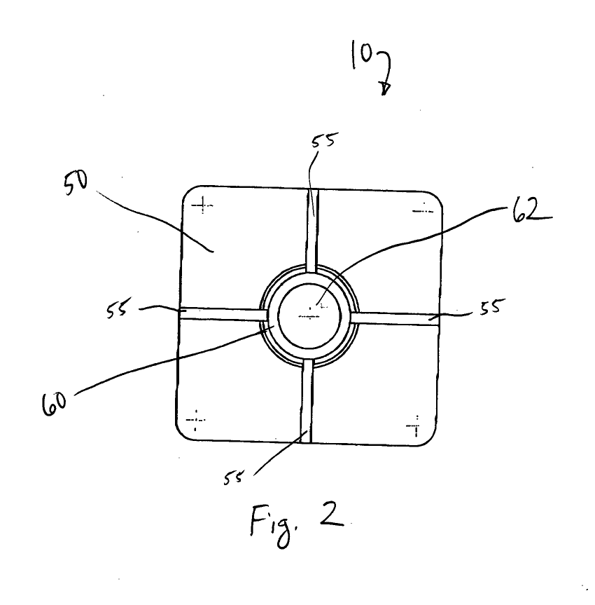

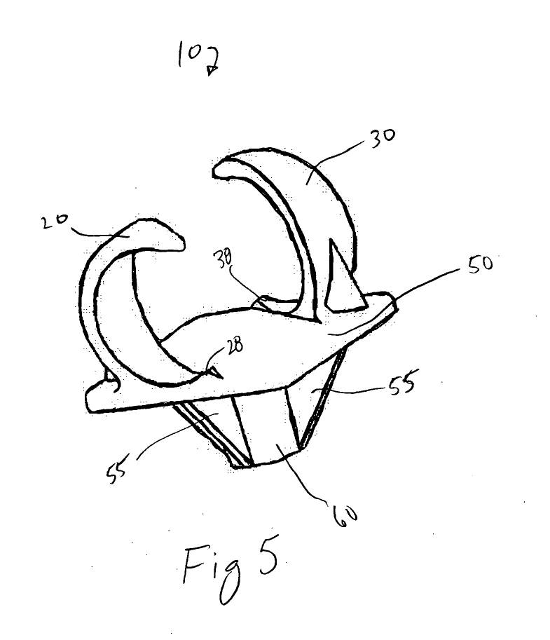

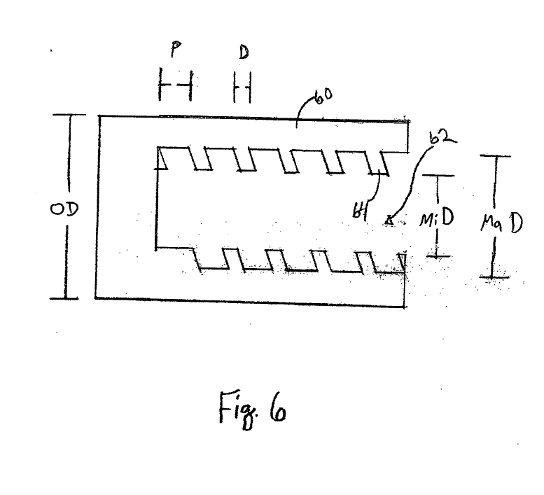

Referring to FIGS. 1-5, bulb changer/holder 10 is shown including base 50. First hooked finger 20 and second hooked finger 30 each protrude from base 50. First finger 20 and second finger 30 are spaced apart from each other by gap 40. Cylindrical member 60 protrudes downward generally perpendicular to base 50. Angled trusses 55 extend between base 50 and cylindrical member 60 to rigidly support cylindrical member 60 to base 50. As is shown in FIG. 6, cylindrical member 60 includes internal cavity 62 including helical threads 64 for threadingly engaging changer/holder 10 to an extension pole. Although the described embodiment of changer/holder 10 includes an internal cavity and female threads for engaging with a threaded male member on a pole, it will be appreciated that an alternative embodiment changer/holder 10 could include a threaded male member protruding from base 50 for engagement with a female threaded cavity of a pole. In addition, other releasable connections for connecting changer/holder 10 to an extension pole, such as a pin and socket or other quick connector now know or later developed, could be used without departing from the spirit and scope of the instant invention. Furthermore, changer/holder 10 could be integrally connected to an extension pole without departing from the spirit and scope of the instant invention.

In a preferred embodiment of cylindrical member 60 shown in FIG. 6, cylindrical member 60 has an outer diameter, OD, of 0.900 inches. In this embodiment, thread 64 is a square thread having a thread diameter, D, of 0.080 inches, a thread pitch, P, of 0.120 inches, a major diameter, MaD, of 0.750 inches, and a minor, MiD, diameter of 0.620 inches. Such dimensions provide a generally universal female thread in internal cavity 62, which can engage with virtually any pole currently on the market that has a ¾ inch modified Acme male thread consisting of five threads per inch.

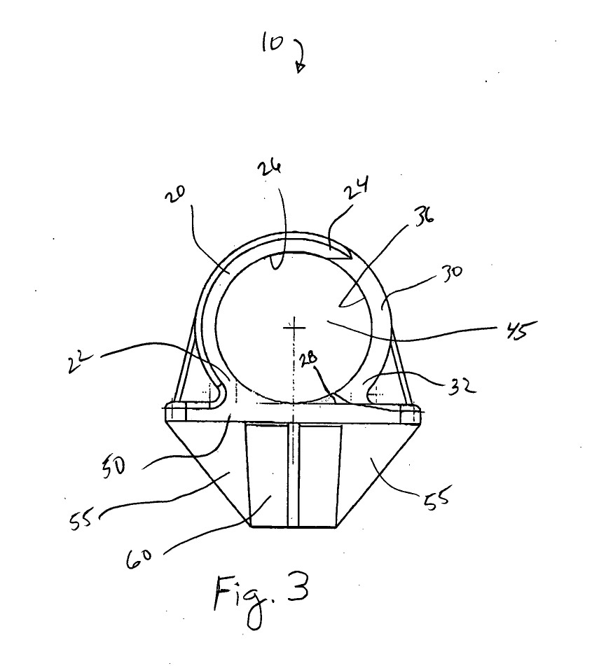

As is shown in FIG. 3, first finger 20 protrudes upward from base 50 at end 22 curving in a clockwise direction to terminal point 24. Concave inner surface 26 of finger 20 generally conforms to the shape and diameter of the outer surface of a tubular light bulb for which holder/changer 10 is designed to grasp; however the inner diameter of inner surface 26 is slightly less than the outer diameter of the bulb, to allow finger 20 to tightly grasp the bulb. As is shown in FIG. 3, terminal point 24 of finger 20 extends beyond the top dead center of the arc formed by finger 20, which would also be the top dead center (i.e. the upper-most center point of the diameter) of the bulb being grasped by holder/changer 10. In addition, nub 28 continues the extension of the arc formed by finger 20 in a counter-clockwise direction beyond the bottom dead center (i.e. the lower-most center point of the diameter) of the bulb. Such extension of finger 20 and nub 28, combined with the flexibility of finger 20, and the slightly smaller inner diameter of surface 26 compared to the bulb being grasped, allows finger 20 to snap into engagement with bulb finger 20 as it is pushed into engagement with the bulb.

Second finger 30 is constructed in similar fashion to first finger 20, except that second finger 30 originates from end 32 located on an opposing side of base 50, and on an opposite side of gap 40, from end 22 of first finger 20. Second finger 30 protrudes upward from base 50 at end 32 curving in a counter-clockwise direction to terminal point 34, such that concave inner surface 36 of finger 30 generally faces concave inner surface 26 of first finger 20. As with first finger 20, concave inner surface 36 of second finger 30 generally conforms to the shape and diameter of the outer surface of a tubular light bulb for which holder/changer 10 is designed to grasp with the inner diameter of inner surface 36 being slightly smaller than the outer diameter of the bulb to allow finger 30 to tightly grasp the bulb. Also, as discussed above with respect to finger 20, terminal point 34 of finger 30 extends beyond the top dead center of the arc formed by finger 30, which would also be the top dead center (i.e. the upper-most center point of the diameter) of the bulb being grasped by holder/changer 10, and nub 38 continues the extension of the arc formed by finger 30 beyond the bottom dead center (i.e. the lower-most center point of the diameter) of the bulb.

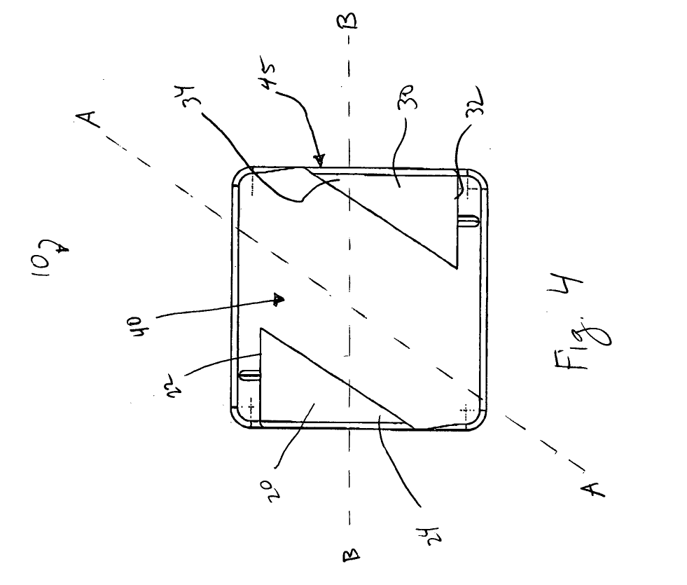

FIG. 4 shows the orientation of fingers 20 and 30 to gap 40. As is shown in FIG. 4, gap 40 extends axially along line A-A to allow provide space for insertion of a tubular bulb such that the tubular axis of the bulb is parallel to line A-A. The bulb being grasped is inserted into gap 40 between fingers 20 and 30, parallel to line A-A. Changer/holder 10 is then rotated counter-clockwise, approximately 1/4 turn (45 degrees) such that the bulbs tubular axis is parallel to line B-B. As changer/holder 10 is rotated, terminal ends 24 and 34 will press against the outer surface of the bulb, flexing upward and wrapping around the bulb until the bulb is in engagement with fingers 20 and 30.

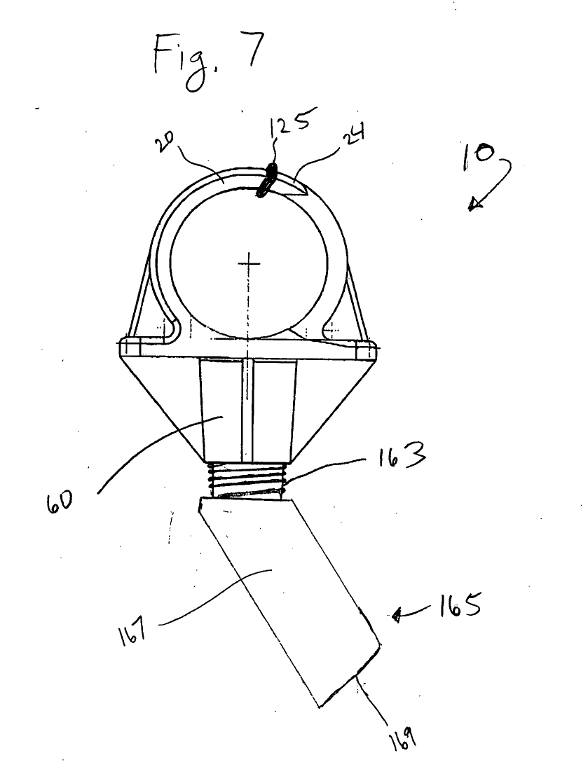

FIG. 7 shows an alternative embodiment of the instant invention in which holder/changer 10 includes an angled base member 165 protruding from cylindrical member 60 of holder/changer 10. Angled base member 165 includes male threaded end 163 for engagement with threads 64 of cylindrical member 60. Cylindrical body 167 of angled base member 165 angles downward from threaded end 163 toward end 169. Cylindrical body 167 is a hollow cylinder having an internal threaded cavity (not shown) that is open at end 169 of cylindrical body 167. The internal threads of cylindrical body 167 are designed in the same manner as threads 64 described above, to allow engagement with the male threaded end of an extension pole. In the embodiment shown in FIG. 7, angled member 165 provides a pole angle of roughly 37 degrees from the normal perpendicular angle (i.e. when the pole is straight below the bulb and perpendicular to the axis of the tubular bulb. This angle provides enough space to push or pull the pole far enough to rotate a bulb being grasped by the holder approximately 90 degrees. It will be appreciated, that although shown as a separate component that threadingly engages with changer/holder 10, angled member 165 can be molded together with changer/holder 10 as a single unit. The two-piece unit of changer/holder 10 and angled member 165 shown in FIG. 7, however allow for increased flexibility, as one changer/holder can be used for both push-pull bulb remove as well as rotational bulb removal. Although angled member 165 described herein includes a threaded cavity for connection to a male threaded member of an extension pole, it will be appreciated that alternative connections, such as those described above with respect to the connection between holder/changer 10, can be utilized without departing from the spirit and scope of the instant invention.

Holder/changer 10 shown in FIG. 7 includes an o-ring, 125, that is wrapped around finger 20. Although only shown around finger 20 near terminal end 24, another similar rubber band may also be included around finger 30. Rubber band 125 is located within a groove formed around the perimeter of finger 20. In addition, it will be appreciated that o-ring 125 can be located anywhere along the length of the fingers. In one embodiment, location of o-ring 125 closer to end 22 or end 32 near base 50 will allow for initial easier engagement of the finger with the light bulb while also providing a more secure connection through the o-ring.

The entire fingers can be constructed of an elastic material, or alternatively only a portion of the fingers can be elastic, and the remainder rigid. In the preferred embodiment, holder/changer 10 is molded as a single unit from Acetal plastic, which is both durable and which includes suitable elastic or flexible properties to permit fingers 20 and 30 to flex as they are snapped into engagement with a bulb. It will be appreciated that the preferred embodiment of the instant invention is constructed to have only a small amount of flexibility or elasticity, as the difference between the diameter of the bulb and the inner diameter of the fingers is very small. By using a material that only has a small amount of flexibility or elasticity, the fingers maintain a tight grasp of the bulb. Molding holder/changer 10 as a single unit provides for ease of production and durability. In an alternative embodiment in which the fingers are constructed primarily of a rigid material, the internal diameters of the fingers are equal to or otherwise larger than the diameter of the bulb. An elastic material is then positioned between the internal surfaces of the fingers such that the elastic material forms an internal diameter that is less than the outer diameter of the bulb. The elastic material can be a rubber band or o-ring located in a groove near the end of the finger, such as o-ring 125 shown in FIG. 7, or alternatively, the elastic material can be a coating that covers the entire surface of the fingers.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

1. An apparatus for grasping a light bulb comprising:
a first finger including a contact surface for engaging a portion of a light bulb orientated along a first line in a plane;
a second finger including a contact surface for engaging a portion of the light bulb orientated along the first line; and
a gap between said first and second fingers, said gap capable of receiving a bulb orientated along a second line in the plane.

2. The apparatus as claimed in claim 1 wherein said contact surface of said first finger and said contact surface of said second finger generally conform to at least a portion of an exterior shape of the bulb.

3. The apparatus as claimed in claim 2 wherein said contact surface of said first finger and said contact surface of said second finger define a diameter that is smaller than an outer diameter of the bulb.

4. The apparatus as claimed in claim 3 wherein said first and second fingers are constructed of a material having elastic properties.

5. The apparatus as claimed in claim 1 further comprising an elastic portion of each of said contact surfaces, said elastic portion of said contact surfaces protruding from said fingers to define a diameter that is smaller than an outer diameter of the bulb.

6. The apparatus as claimed in claim 5 wherein said first and second fingers are constructed of a material having elastic properties and said contact surface of said first finger and said contact surface of said second finger define a diameter that is smaller than an outer diameter of the bulb.

7. The apparatus as claimed in claim 5 wherein said contact surface of said first finger and said contact surface of said second finger define a diameter that is equal to or larger than an outer diameter of the bulb.

8. The apparatus as claimed in claim 1 further comprising a base including a threaded cavity adapted to receive a male threaded member.

9. The apparatus as claimed in claim 8 wherein said base further comprises an angled member, said angled member including said threaded cavity adapted to receive the male threaded member.

10. The apparatus as claimed in claim 1 further comprising an angled base member protruding from the apparatus adapted for connection to a pole.

11. The apparatus as claimed in claim 8 wherein said angled member includes a thread male member for receipt in said threaded cavity of said base, and a threaded cavity adapted to receive an other threaded male member.

12. The apparatus as claimed in claim 1 wherein said first finger generally hooks in a first direction and said second finger generally hooks in a second direction generally opposite of said first direction.

13. The apparatus as claimed in claim 12 wherein said first finger curves upward in a clockwise direction, and said second finger curves upward in a counter-clockwise direction.

14. The apparatus as claimed in claim 13 wherein a point of origination for said first finger and a point of origination for said second finger are spaced apart about a first line to form said gap and about a second line to form a second gap.

15. A method of grasping a light bulb comprising the steps of:
providing an apparatus including a pair of hooked fingers on opposite sides of a gap;
positioning the light bulb within the gap; and
rotating the apparatus to permit one of the fingers to snap-engage the bulb from a first side and the other of the fingers to simultaneously snap-engage the bulb from the opposing side.

16. An apparatus for grasping a light bulb comprising:
a first finger including a terminal end extending in a first general direction;
a second finger including a terminal end extending in a second general direction, said second direction being generally opposite of said first direction; and
a gap between said first finger and said second finger for positioning a light bulb in non-engagement with said first and second fingers;
wherein rotation of the apparatus about a light bulb positioned in said gap causes said terminal ends of said first and second fingers to engage the bulb.

17. The apparatus as claimed in claim 16 wherein said terminal end of said first finger and said terminal end of said second finger each extend beyond an upper-most point of a diameter of a light bulb that is fully engaged with the apparatus.

18. The apparatus as claimed in claim 16 wherein said first finger curves upward in a clockwise direction, and said second finger curves upward in a counter-clockwise direction.

19. The apparatus as claimed in claim 18 wherein a point of origination for said first finger and a point of origination for said second finger are spaced apart about a first line to form said gap and about a second line to form a second g ap.
